(19) United States
(12) Patent Application Publication
(10) Pub. No.: US 2026/0326011 A1
(43) Pub. Date: Oct. 22, 2026

(54) VACUUM FILTRATION SYSTEM FOR A DRY BULK TRAILER AND METHOD OF USING THE SAME

(71) Applicant: BULK TANK, INC., Park Hills, MO (US)

(72) Inventors: David SISK, Bonne Terre, MO (US); Andy BOYER, Bonne Terre, MO (US); Roger BREAKFIELD, Farmington, MO (US); Peter KEMP, Crestwood, MO (US); Travis KINNEMAN, Fredericktown, MO (US)

(21) Appl. No.: 19/105,633

(22) PCT Filed: Aug. 18, 2023
(86) PCT No.: PCT/US2023/072467

§ 371 Date: Feb. 21, 2025

Related U.S. Application Data
(60) Provisional application No. 63/399,770, filed on Aug. 22, 2022.

(51) Int. Cl. B01D 46/38; B01D 46/42; B01D 46/46; B01D 46/71

(52) U.S. Cl. CPC B01D 46/38; B01D 46/4272; B01D 46/46; B01D 46/71

(57) ABSTRACT

A filtration system for a dry bulk trailer tank includes a canister containing a filter media separating a dusty air inlet and a clean air outlet on the canister. A dusty air line connects the tank with the dusty air inlet. A clean air line connects the clean air outlet with the exterior environment atmosphere. In a loading mode material is pneumatically conveyed from the tank through the dusty air line into the canister, through the filter media and from the canister through the clean air outlet and the clean air line. In a cleaning mode air flow is reversed and flows from the exterior environment atmosphere through the clean air line and the clean air outlet into the canister, through the filter media dislodging material from the filter media, and from the canister with dislodged material through the dusty air inlet and dusty air line to the tank.

### CROSS-REFERENCE TO RELATED APPLICATIONS

The present invention is the US National Stage under 35 U.S.C. § 371 of International Application No. PCT/US2023/072467 filed on Aug. 18, 2023, which claims the priority to U.S. Provisional Appl. No. 63/399,770 filed Aug. 22, 2022 which is incorporated herein by reference.

### STATEMENT REGARDING FEDERALLY SPONSORED RESEARCH

Not Applicable.

### TECHNICAL FIELD

This disclosure relates to a vacuum filtration system and its operation for a dry bulk tank trailer assembly.

### BACKGROUND ART

Bulk tank trailer assemblies are typically tank trailers for the movement of bulk dry goods such as, for example and without limitation, wheat, corn, flour, plastic pellets, granular materials, or other materials capable of pneumatic conveyance. Bulk tank trailer assemblies typically are loaded and unloaded by pneumatically conveying the material into or out of the tank of the bulk tank trailer assembly. Filtration systems for typical dry bulk tank trailer assemblies separate the air conveying the material from dust and other particles or debris when conveying such materials to and from such vehicles or storage silos, during operations of the system. This allows for capture of the conveyed material and discharge of filtered air with minimal dust or debris being discharged to the environment. The disclosure also relates to a system and method for cleaning the filter media used in the filtration system. In operation, the filter media can become clogged, blocked, or otherwise have reduced performance due to interference by filtered dust or other particulate from the material conveying air being discharged from the filtration system. Therefore, it is desirable to clean the filter media to improve performance of the filtration system and/or the pneumatic conveyance system.

### BRIEF DESCRIPTION OF THE DRAWINGS

In the accompanying drawings which form part of the specification:

FIG. 1 is a schematic depiction of a dry bulk tank trailer including a filter system.

FIG. 2 is a left side view of the filtration system and corresponding components of the dry bulk tank trailer shown in FIG. 1.

FIG. 3 is a rear view of the filtration system and corresponding components of the dry bulk tank trailer shown in FIG. 1

FIG. 4 is a right-side view of the filtration system and corresponding components of the dry bulk tank trailer shown in FIG. 1.

FIG. 5 is a top view of the filtration system and corresponding components of the bulk tank trailer shown in FIG. 1.

FIG. 6 is a partial left side view of the canister of the filtration system of FIGS. 2-5.

FIG. 7 is a partial rear view of the canister of the filtration system of FIGS. 2-5.

FIG. 8 is a partial right-side view of the canister of the filtration system of FIGS. 2-5.

FIG. 9 is an isometric view of the canister of the filtration system of FIGS. 2-5.

FIG. 10 is a top view of the canister of the filtration system of FIGS. 2-5.

FIG. 11 is a schematic view of a control system for the filtration system and pneumatic conveyance system of the dry bulk tank trailer shown in FIG. 1.

FIG. 12 is a schematic illustration of the valve states for a plurality of valves when configured for loading the dry bulk tank trailer of FIG. 1.

FIG. 13 is a schematic illustration of the valve states for a plurality of valves when configured for cleaning the filtration system of the dry bulk tank trailer of FIG. 1

In the figures, corresponding reference characters and symbols indicate corresponding parts in the several views of the drawings.

### DETAILED DESCRIPTION

The following detailed description illustrates the disclosed systems and methods by way of example and not by way of limitation. The description enables one skilled in the art to make and use the disclosed apparatuses and the methods, describes several embodiments, adaptations, variations, alternatives, and uses of the same, including what is presently believed to be the best mode of making and using the apparatuses. Additionally, it is to be understood that the disclosed embodiments are not limited to the details of construction and the arrangements of components set forth in the following description or illustrated in the drawings. The claimed systems and/or methods are capable of other embodiments and of being practiced or being carried out in various ways. Also, it is to be understood that the phraseology and terminology used herein is for the purpose of description.

As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to practice the disclosure and are not intended to limit the scope of the appended claims.

Unless otherwise defined, all technical and scientific terms used herein have the same meaning as commonly understood by one of ordinary skill in the art to which this disclosure belongs. The terminology used herein is for the purpose of describing particular example embodiments only and is not intended to be limiting. As used herein, the singular forms “a”, “an”, and “the” may be intended to include the plural forms as well, unless the context clearly indicates otherwise. The terms “comprises”, “comprising”, “including”, and “having” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps can be employed.

When an element, object, device, apparatus, component, region or section, etc., is referred to as being “on”, “engaged to or with”, “connected to or with”, or “coupled to or with” another element, object, device, apparatus, component, region or section, etc., it can be directly on, engaged, connected or coupled to or with the other element, object, device, apparatus, component, region or section, etc., or intervening elements, objects, devices, apparatuses, components, regions or sections, etc., can be present. In contrast, when an element, object, device, apparatus, component, region or section, etc., is referred to as being “directly on”, “directly engaged to”, “directly connected to”, or “directly coupled to” another element, object, device, apparatus, component, region or section, etc., there may be no intervening elements, objects, devices, apparatuses, components, regions or sections, etc., present. Other words used to describe the relationship between elements, objects, devices, apparatuses, components, regions or sections, etc., should be interpreted in a like fashion (e.g., “between” versus “directly between”, “adjacent” versus “directly adjacent”, etc.).

As used herein the phrase “coupled” will be understood to mean two or more elements, objects, devices, apparatuses, components, etc., that are directly or indirectly connected to each other in an operational and/or cooperative manner such that operation or function of at least one of the elements, objects, devices, apparatuses, components, etc., imparts or causes operation or function of at least one other of the elements, objects, devices, apparatuses, components, etc. Such imparting or causing of operation or function can be unilateral or bilateral. The phrase “in fluid communication” refers to two or more elements, objects, devices, apparatuses, components, etc., that are directly or indirectly connected to each other using a connection suitable for fluid (e.g., gas, liquid, and/or fluidized granular solids) to flow between each other, e.g., a pipe, duct, channel, or the like. There may be one or more intervening elements, objects, devices, apparatuses, components, etc. between elements, objects, devices, apparatuses, components, etc. in fluid communication in the case that such elements are indirectly connected to each other. It should be understood that elements, objects, devices, apparatuses, components, etc. that are in fluid communication and are depicted as being serially coupled (e.g., by a pipe) can in some embodiments be direct connections without intervening elements, objects, devices, apparatuses, components, etc.

As used herein, “line” or similar terminology should be understood to mean a connection for conveying fluids ((e.g., gas, liquid, and/or fluidized granular solids) and is typically a pipe. Other suitable components can be used in alternative embodiments.

As used herein, the term “and/or” includes any and all combinations of one or more of the associated listed items. For example, A and/or B includes A alone, or B alone, or both A and B.

Although the terms first, second, third, etc. can be used herein to describe various elements, objects, devices, apparatuses, components, regions or sections, etc., these elements, objects, devices, apparatuses, components, regions or sections, etc., should not be limited by these terms. These terms may be used only to distinguish one element, object, device, apparatus, component, region or section, etc., from another element, object, device, apparatus, component, region or section, etc., and do not necessarily imply a sequence or order unless clearly indicated by the context.

Moreover, it will be understood that various directions such as “upper”, “lower”, “bottom”, “top”, “left”, “right”, “first”, “second” and so forth are made only with respect to explanation in conjunction with the drawings, and that components may be oriented differently, for instance, during transportation and manufacturing as well as operation. Because many varying and different embodiments may be made within the scope of the concept(s) taught herein, and because many modifications may be made in the embodiments described herein, it is to be understood that the details herein are to be interpreted as illustrative and non-limiting.

The apparatuses/systems and methods described herein can be implemented at least in part by one or more computer program products comprising one or more non-transitory, tangible, computer-readable mediums storing computer programs with instructions that may be performed by one or more processors. The computer programs may include processor executable instructions and/or instructions that may be translated or otherwise interpreted by a processor such that the processor may perform the instructions. The computer programs can also include stored data. Non-limiting examples of the non-transitory, tangible, computer readable medium are nonvolatile memory, magnetic storage, and optical storage.

As used herein, the term module can refer to, be part of, or include an application specific integrated circuit (ASIC); an electronic circuit; a combinational logic circuit; a field programmable gate array (FPGA); a processor (shared, dedicated, or group) that performs instructions included in code, including for example, execution of executable code instructions and/or interpretation/translation of uncompiled code; other suitable hardware components that provide the described functionality; or a combination of some or all of the above, such as in a system-on-chip. The term module can include memory (shared, dedicated, or group) that stores code executed by the processor.

The term code, as used herein, can include software, firmware, and/or microcode, and can refer to one or more programs, routines, functions, classes, and/or objects. The term shared, as used herein, means that some or all code from multiple modules can be executed using a single (shared) processor. In addition, some or all code from multiple modules can be stored by a single (shared) memory. The term group, as used above, means that some or all code from a single module can be executed using a group of processors. In addition, some or all code from a single module can be stored using a group of memories.

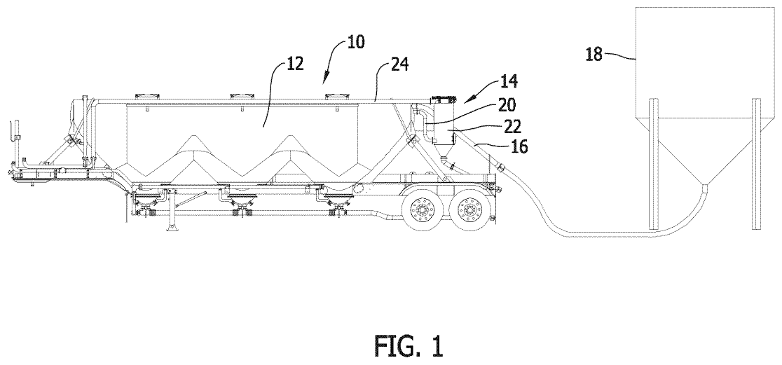

Referring generally to FIG. 1, a dry bulk trailer 10 is shown according to one embodiment. The dry bulk trailer 10 can be configured in a variety of manners consistent with this disclosure. The dry bulk trailer 10 includes a tank 12 for storing the dry bulk material, a filtration system 14 for filtering air being discharged to the environment, and a fill pipe 16 for receiving material from a source 18 (e.g., a storage silo, railcar, tank trailer, dry bulk trailer, or other storage system or source of material). The dry bulk trailer 10 is adapted and configured to receive and discharge bulk dry goods (e.g., in a granular form) using pneumatic conveyance. As air is used to convey the material into and out of the tank 12 of the dry bulk trailer 10, the air is discharged to the environment from the tank 12 at some point during operation in order to either create a vacuum within the tank 12 to draw material into the tank or to relieve pressure within the tank in the case in which material is blown into the tank creating positive pressure in the tank. The air being discharged from the tank is filtered in order to prevent the material being conveyed from being discharged to the environment using a vacuum filtration system 14. The filtration systems and pneumatic conveyance systems (e.g., an air mover and/or the filtration system) of various configurations of the dry bulk trailer 10 fall, generally, into three types.

A first type uses a vacuum, as previously noted, to draw the material into the tank 12 for storage. More specifically, the combined vacuum filtration system and pneumatic conveyance system uses a source of vacuum, such as a blower to draw fluidized granular material, using air, from a storage container, such as a silo, through the fill pipe 16 into the dry bulk trailer 10. The use of pneumatic conveyance and/or the fluidization of the granular material results in some material being entrained within the air being used for conveyance or otherwise loose within the conveyance air. This results in dusty air containing a portion of the material being conveyed. As the granular material is moved into the tank 12 dusty air enters and/or is created within the tank 12. This phenomenon occurs in all types of vacuum filtration systems and pneumatic conveyance systems. The dusty air is processed by the filtration system 14. In processing by the filtration system 14, the dusty within the tank 12 goes through a dusty air line 20 into a filter canister 22 where it passes through filtration media, such as filter tubes, filter bags, pleated cartridge filters, or other filter media positioned within the filter canister 22. The granular material cannot pass through the filter media and is deposited on the filter media and/or drops down into the bottom of the filter canister 22. The air, with granular material at least partially removed, passes through the filter media. The filtered air then goes through a vacuum line 24 to a blower (not shown), or other vacuum source, providing the vacuum, where the filtered air is discharge to atmosphere. Some of the filtered dust permeates into the filter media and collects on the surface of the filter media. The rest of the dust collects on the bottom of the filter canister. The dust on the filter media increases the back pressure through the system increasing the amount of time required to completely load the trailer. In other words, the buildup on the filter media impedes airflow decreasing the ability of the blower to evacuate air from the tank and build vacuum in the tank which reduces the effectiveness of the pneumatic conveyance. The accumulated dust on the bottom of the filter canister 22 can eventually block the flow of air through the filter and/or block the outlet of the dusty air line 20 preventing the flow of dusty air into the filtration system 14 and/or preventing or impeding the creation of a vacuum within the tank 12. Therefore, the filter canister 22 then must be emptied to remove the blocking granular material. Additionally, the weight of the collected dust in the filter canister 22 can be enough, in some instances, to cause enough stress on the mounting brackets to eventually cause the brackets to crack and fail. It is therefore desirable to remove the collected dust from the filter canister 22.

A second type of filtration system and pneumatic conveyance system pressurizes the storage container 18, such as a silo, with a pressure source, such as a blower, to push granular product through the fill pipe 16 into the tank 12 of dry bulk tank trailer 10. The dusty air then goes through the dusty air pipe 20 into the filter canister 22, where it is filtered in the same manner as just described with respect to the first type of system using a vacuum to pneumatically convey the material. The filtered air from the filter is then discharged to atmosphere.

A third type of filtration system and pneumatic conveyance system uses a pressure source, such as a blower, pushes granular material into a storage container, such as a silo, the dusty air then goes into the dusty air line 20 of the filter 14 and is filtered. The filtered air is then discharged to atmosphere.

In operation of all types of pneumatic conveyance systems, filtering the conveying air to remove the dust is beneficial because the dust can become trapped in the close clearances of a blower (e.g., when the blower is providing vacuum for conveying the material) causing the blower to seize thereby damaging the blower, or the drive system of the blower. In some embodiments, the blower (not shown) is driven by a tractor (not shown) for towing the dry bulk trailer 10. For example, and without limitation, the tractor may drive the blower using a power take off which is optionally driven by an internal combustion engine of the tractor. Alternatively, the blower can be driven by an electric motor or otherwise be suitably driven to move air. Additionally, dust released to atmosphere is an inhalation hazard, and explosion hazard. Given the limitations of a blower driven system, e.g., a power take off driven blower may be operable in only a single non-reversable direction preventing reversal of air flow and/or the desirability of filtering dusty air to reduce hazards, the advantages of the bulk dry trailer 10 and included systems presented herein will become evident in view of this disclosure.

The filtration system described herein and its methods of operation can be used with any of these types of filtration systems and pneumatic conveyance systems previously described.

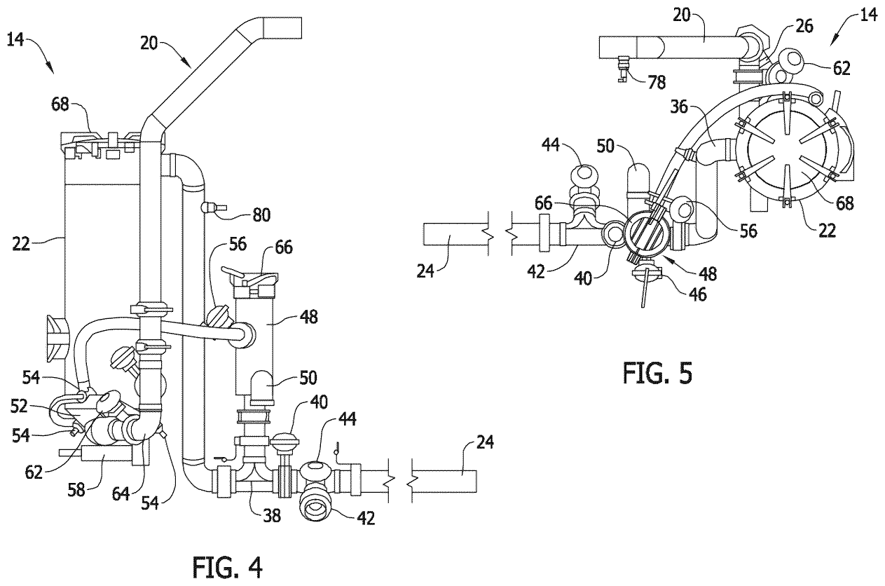

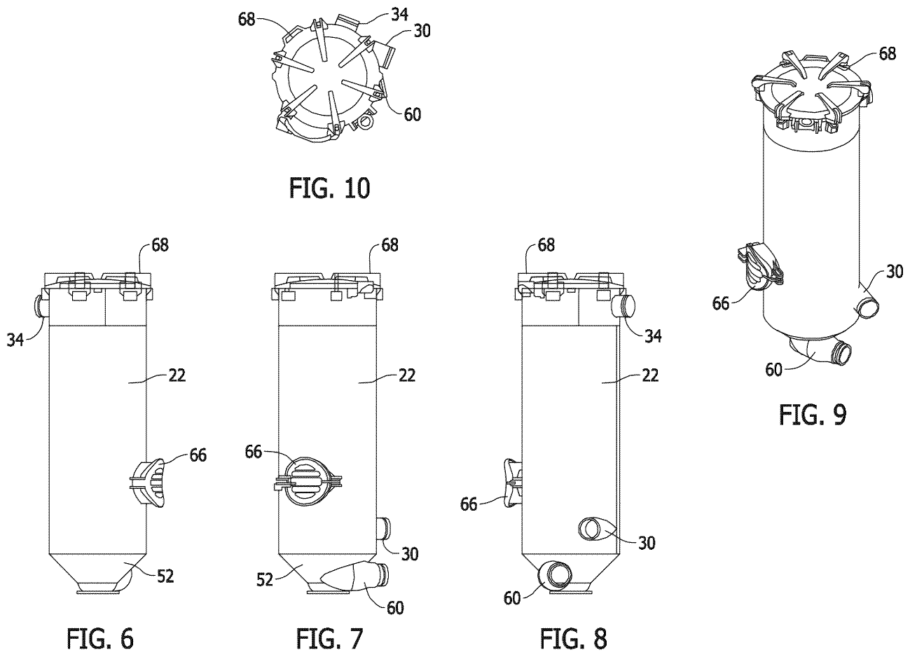

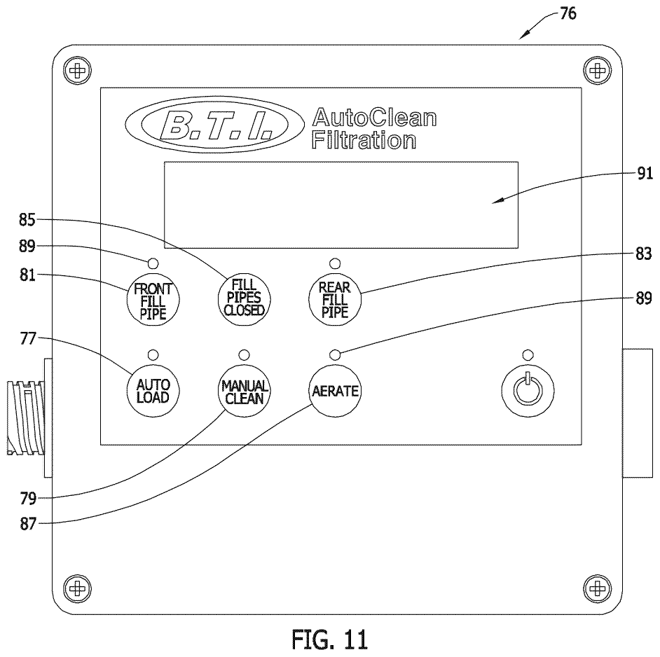

Referring generally to FIGS. 1-13, in the preferred embodiment of the bulk tank trailer 10 and associated systems (e.g., the filtration system 14 and pneumatic conveyance system) operates using a vacuum as described with respect to the first type of filtration and conveyance system previously described. Referring to FIGS. 1-5 and 12-13, the vacuum filter system 14 is shown in greater detail according to one embodiment. A blower (not shown) is in fluid communication with the vacuum line 24 to provide a source of vacuum to the filtration system 14 and which is used in conveying material into the tank 12 when loading the dry bulk trailer 10. The blower being in fluid communication with the filtration system 14 and other components of the dry bulk trailer 10 (e.g., tank 12 and fill pipe 16) allows for removal of air from the tank 12 and drawing in of air into the tank 12 along with material from the material source 18 (e.g., a silo). The air conveying the material (and the material) enters the tank 12 and dusty air is pulled through by the blower into the dusty air line (or dusty air inlet) pipe 20 of the filtration system 14.

The filtration system 14 further includes a dusty air line 20 fitting 26 (e.g., a Y fitting or other suitable fitting) for splitting the dusty air line 20. In fluid communication with the fitting 26, and by extension the dusty air line 20, is a first branch from the dusty air line 20, a dusty air inlet line 28. The dusty air inlet line 28 is in fluid communication with a dusty air inlet 30 of the filter canister 22. The dusty air inlet is an opening or port allowing for dusty air from the dusty air line 20 to enter the filter canister 22 for filtering of the dusty air. In some embodiments, a dusty air inlet line valve 32 is positioned between the fitting 26 and the dusty air inlet 30 of the filter canister 22. The dusty air inlet line valve 32 is any suitable valve for controlling the flow of dusty air through the dusty air inlet line 30. For example, the dusty air inlet line valve 32 can be a quarter turn butterfly valve actuated manually, pneumatically, electrically, or otherwise manipulable to control flow.

The filtration system 14 further includes filter media (not shown) positioned within the filter canister 22. This can be any suitable filter media for filtering particulate from air. The filter media prevents at least some dust, particulate, granular material, or other solids entrained in the air pneumatically conveying material into the tank 12 from passing through the filter. Filtered air passing through the filter media enters an area of the filter canister 22 separated from the dusty air inlet 30 by the filter media. Filtered air can then exit the filter canister through a clean air outlet 34 and enter a clean air line 36. In some embodiments, the filter canister 22 and the filter media are of the type described in Applicants U.S. patent application Ser. No. 17/300,958. For example, the filter media can include a plurality of supported porous tubes made generally of a polymer, that have very miniscule openings through them, in the range of microns of porosity, so as to filter the incoming air as it passes through the tubes in the filtration system, and to purify it for its further usage in the air conveying of such granular materials, during its handling. The clean air line 36 is in fluid communication with the clean air outlet 34 and by extension the filter canister 22. The clean air line 36 is in fluid communication with a clean air line fitting 38. The clean air line fitting 38 is, in some embodiments, a T fitting, but can be any suitable fitting. The clean air line fitting 38 allows for fluid communication with a vacuum source such as a blower and separate fluid communication with a source of atmospheric air (filtered or unfiltered in different embodiments).

The filtration system 14 further includes a vacuum line 24 in fluid communication with the clean air line fitting 38. The vacuum line 24 is in fluid communication with the vacuum source (e.g., a blower) such that air is evacuated from the tank 12 through the dusty air line 20, through the filter canister 22, through the clean air line 36, and passes through the vacuum line and the vacuum source (e.g., the blower). The vacuum line 24 includes a vacuum shut off valve 40. The vacuum shut off valve 40 is any suitable valve for controlling the flow of air through the vacuum line 24. For example, the vacuum shut off valve 40 can be a quarter turn butterfly valve actuated manually, pneumatically, electrically, or otherwise manipulable to control flow. The vacuum shut off valve 40 can be shut to prevent the building of vacuum within the tank 12 while the blower continues running. Advantageously, allowing the blower to continue operating even when vacuum is not needed reduces strain on blower by reducing the number and frequency of start/stop sequences. This is further advantageous in embodiments where the blower is driven by a power take off from an engine whereby the engine or power take off does not need to be cycled.

The filtration system 14 further includes a vacuum dump fitting 42 that is in fluid communication with the vacuum line 24. The vacuum dump fitting 42 is any suitable fitting and can be, for example and without limitation, a T fitting. The vacuum dump fitting provides for fluid communication between the vacuum line 24 and a vacuum dump valve 44. The vacuum dump valve 44 is any suitable valve for controlling the flow of air through or into the vacuum line 24. For example, the vacuum dump valve 44 can be a quarter turn butterfly valve actuated manually, pneumatically, electrically, or otherwise manipulable to control flow. The vacuum dump valve 44 is operable to relieve vacuum when the blower is operated and when the vacuum shut off valve 40. The vacuum dump valve 44 can be opened to atmosphere when the blower is operating and the vacuum shut off valve 40 is closed. This allows the blower to draw air from atmosphere to reduce strain on the blower rather than continually build vacuum in the vacuum line 24.

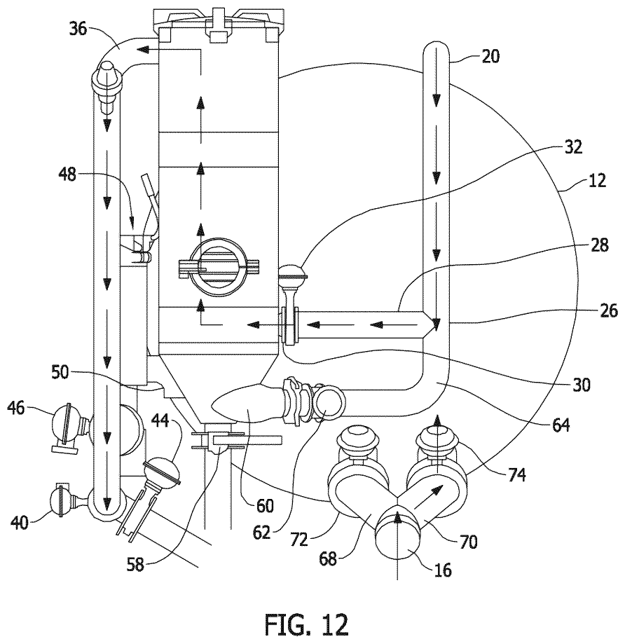

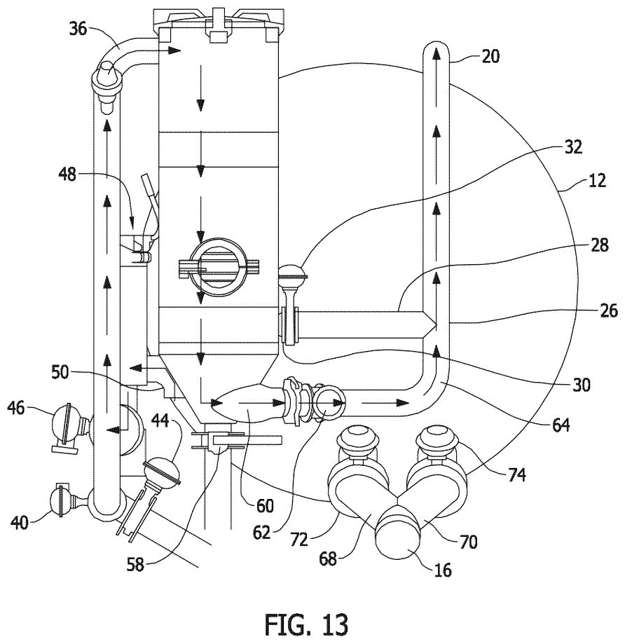

As previously described, the clean air line fitting 38 can be a T fitting with one portion being in fluid communication with the vacuum shut off valve 40, the vacuum dump valve 44, and the vacuum line 24. The other portion of the clean air line fitting 38 is in fluid communication with an air source. This air source provides air for cleaning the filter media within the filter canister 22 which is described in greater detail herein with respect to FIGS. 12 and 13. To clean the filter media, air is provided from the air source and through the clean air line 36 to flow through the filter media opposite the flow when pneumatically conveying material into the tank 12. This reverse flow dislodges material on the filter media thereby cleaning the filter material. The air source can be atmosphere, air from the blower providing vacuum during loading, air from a separate blower, or other air source. In the depicted embodiment, the air for cleaning the filter media is provided from atmosphere and through a secondary filtration system to reduce foreign debris from entering the filtration system 14 and/or the tank 12 when cleaning the filter media.

An atmospheric inlet valve 46 is in fluid communication with the clean air line fitting 38. The atmospheric inlet valve 46 is any suitable valve for controlling the flow or air into the clean air line 36 through the clean air line fitting 38. For example, the atmospheric inlet valve 46 can be a quarter turn butterfly valve actuated manually, pneumatically, electrically, or otherwise manipulable to control flow. The atmospheric inlet valve 46 can be closed to allow for the blower to provide a vacuum for pneumatically conveying material into the tank 12 The atmospheric inlet valve 46 can be opened to provide a source of air for cleaning the filter media as will be described in greater detail with respect to FIGS. 12 and 13. An inlet air filter 48 is in fluid communication with the atmospheric inlet valve 46 to provide filtered air to the atmospheric inlet valve. The inlet air filter 48 can be any suitable air filter. In the depicted embodiment, the inlet air filter 48 includes a canister and filter media similar to or the same as the filter system previously described with regard to reference numeral 22. The inlet air filter 48 further includes an inlet 50 that allows unfiltered atmospheric air to enter the inlet air filter 48. This air enters an enclosure (e.g., a canister as depicted) and passes through the filter media therein which then exits into the clean air line 36 when the atmospheric inlet valve 46 is open (as is described in greater detail with respect to FIGS. 12 and 13). This provides a source of clear air for cleaning the filter media in the filter canister 22 used to clean the air used to pneumatically convey material into the tank 12.

In alternative embodiments, the filtration system 14 omits the inlet air filter 48. The air used for cleaning the filter media is itself unfiltered. The filter media can, in some cases, prevent debris from entering the tank 12. Omission of the inlet air filter 48 can be advantageous in that it reduces the weight of the unloaded dry bulk trailer 10. As the total weight of a loaded dry bulk trailer is limited by regulation, reducing the weight of the unloaded dry bulk trailer allows for a greater amount of material to be loaded onto the dry bulk trailer for transportation.

In some embodiments, the filtration system 14 further includes an aeration system. The aeration system can be used to aerate filtered material that collects in the bottom of the canister 22 (e.g., in a conical lower section 52). This is useful in dislodging or otherwise facilitating the removal of the collected material when cleaning the filter media and the canister 22. The aeration system includes a plurality of aerators 54 for introducing air into the collected material to aerate it (e.g., fluidize the material by suspending it in air or otherwise introducing air into the material). Any suitable aerator 54 can be used including, for example and without limitation, the aerator described in Applicant's U.S. Pat. No. 8,087,816. In the depicted embodiment, three aerators 54 are used. In alternative embodiments, other numbers of aerators are used.

The aerators 54 are in fluid communication with an air line for providing air to the aerators. The air line is in turn in fluid communication with the inlet air filter 48 such that the aerators 54 can be provided with clean air for introduction into the filter canister 22 and ultimately into the tank 12 as will be described in greater detail later herein with reference to FIGS. 12 and 13. An aeration valve 56 is positioned between the inlet air filter 48 and the air line supplying the aerators 54. The aeration valve 56 is any suitable valve for controlling the flow of air through the air line supplying the aerators 54. For example, the aeration valve 56 can be a quarter turn butterfly valve actuated manually, pneumatically, electrically, or otherwise manipulable to control flow. In operation, the air being supplied to the aerators 54 is drawn from the atmosphere as a result of the difference in pressure between the atmosphere and the vacuum in tank 12 which is created during loading of the tank 12. Therefore, opening the aeration valve 56 creates a pressure differential between atmosphere and the vacuum in the tank 12 thus drawing air into the inlet air filter 48 and being supplied to the aerators 54. In embodiments including the aeration system, the aeration system can be activated by opening the aeration valve 56 when there is a vacuum in the tank 12. This can be used in combination with other functions such as the cleaning of the filter media or can be used independently (e.g., in preparation for manually cleaning the filter canister 22 using a clean out valve 58). The clean out valve 58 is any suitable valve and can be, for example, a manually operated butterfly valve.

In alternative embodiments, the filtration system 14 and the dry bulk trailer 10 omit the aeration system. This reduces the weight of the unloaded trailer which as previously explained provides an advantage in that additional material can be loaded and transported.

The filtration system 14 further includes a recycled dust outlet 60. The recycled dust outlet 60 allows for dust collected in the filter canister 22 (e.g., including any conical lower section 52) and/or any dust or other material cleaned from the filter media to be removed from the filter canister 22 (e.g., to complete cleaning of the filter system 14). The recycled dust outlet 60 is in fluid communication with a dust recycle valve 62. The dust recycle valve 62 is any suitable valve for controlling the flow of air, dust or particulate, and/or air entrained dust or particulate out of the filter canister 22 and into a dust recycle line 64. For example, the dust recycle valve 62 can be a quarter turn butterfly valve actuated manually, pneumatically, electrically, or otherwise manipulable to control flow. The dust recycle valve 62 is in fluid communication with the dust recycle line 64. The dust recycle line allows for return of the dust cleaned from the filter media and/or the filter canister 22. The dust recycle line 64 is in fluid communication with the dusty air line 20 through the fitting 26. As explained in greater detail with reference to FIGS. 12 and 13, this allows for the dust and/or other material cleaned from the filter media and/or canister 22 to be recycled into the tank 12 through reversing the flow through the dusty air line 20 (e.g., which flows dusty air into the filter canister 22 during loading of the tank 12 due to the application of vacuum provided by the blower). Returning the recycled material to the tank 12 through the dusty air line 20 through reversal of the flow provides several advantages over returning recycled material to other locations in the system/trailer. For example, the dusty air line 20 is typically mostly clear of material and therefore the recycled material can easily flow backward into the tank when drawn in by the vacuum of the tank (e.g., as described in greater detail later herein with reference to FIGS. 12 and 13). This is in contrast to, for example, returning the recycled material to the fill pipe 16. The fill pipe 16 will continue to be mostly full of material being conveyed into the tank 12. In some cases, the material continues to be pneumatically conveyed through the fill pipe 16 even during cleaning of the filtration system 14 as a result of the residual vacuum in the tank 12. Alternatively, material can remain in the fill pipe 16 simply as residual material not yet loaded into the tank 12. The material in the fill pipe 16 impedes the introduction of the material cleaned form the filter media and the canister 22 in the event that the recycled dust outlet feeds the fill pipe. In other words, there is less room in the fill pipe 16 to receive the material as compared to the dusty air inlet 20 and therefore it is easier to evacuate the material from the canister 22 into the dusty air inlet 20. Therefore, it improves cleaning of the filtration system 14 to return the recycled dust to the tank 12 through the dusty air inlet 20.

In some embodiments, the filtration system 14 omits the separate recycled dust outlet 60, the dust recycle valve 62, the dusty air inlet line valve 32, the dust recycle line 64, and the fitting 26. In such embodiments, when cleaning the filter media and canister 22 by reversing the flow of air (e.g., using the vacuum of the tank 12 to draw in air) the collected material flows through the dusty air inlet line 28 into the dusty air inlet 20 and back into the tank 12. This arrangement can provide some advantages in that it reduces the weight of the unloaded dry bulk trailer 10 allowing for additional material to be loaded and transported.

However, the arrangement as depicted with the separate dusty air inlet line 28 and the separate dust recycle line 64 provide different advantages. Separate lines for input into the canister 22 and output from the canister 22 allows for different placement of the dusty air inlet line 28 and the separate dust recycle line 64 to provide for different advantages. For example, placement of the dust recycle line 64 as low as possible on the canister 22 allows for greater removal of material in the canister 22 (e.g., material positioned below dust recycle line 64 and the recycled dust outlet 60 might not be removed). Thus, the recycled dust outlet 60 and the dust recycle line 64 are in fluid communication with the lower conical section 52 of the canister 22. However, such a placement is less effective for the input of dusty air into the canister 22 for filtering. As dust collects in the canister 22, it can build up and obstruct the inlet supplying dusty air to the filtration system 14 and providing the fluid communication between the blower and the tank 12 and fill pipe 16 providing for pneumatic conveyance of the material. The blockage (partial or complete) impedes the ability of the system to provide vacuum for conveyance of the material. Placement in the lower conical section 52 can also impinge on incoming dusty air given the reduced diameter of the canister 22 where the pipe feeds the canister. The proximity of the canister wall can also cause dust to be more likely to be deposited on the wall. Therefore, there are advantages in having the dusty air inlet 30 positioned higher up relative to the recycled dust outlet 60. This reduces the likelihood that that dusty air inlet 30 becomes blocked.

Using separate dusty air inlet line 28 and the separate dust recycle line 64, along with corresponding dusty air inlet 30 and recycled dust outlet 60, allows for the system to achieve the benefits of both placements for each component. The separate dusty air inlet line 28 can be placed higher up on the canister 22 to reduce blockages. At the same time, the dust recycle line 64 can be placed low on the canister 22 to increase the amount of collected material that is removed when cleaning the filter media and/or the canister 22.

The filtration system 14 can include additional components to enhance the functions and usability of the system. For example, the filtration system 14 can include inspection ports 66, access covers 68 (e.g., hinged manhole style coverings), or the like. Such ports and accesses can provide the ability to inspect or manually clean various components of the filtration system 14 and/or other components. In some embodiments, the dry bulk tank trailer 10 includes a fill system that includes a branching fill pipe 16. The fill pipe 16 branches into a front fill pipe 68 and a rear fill pipe 70. A front fill pipe control valve 72 and a rear fill pipe control valve 74. The front fill pipe control valve 72 can be selectively opened and closed to fill or cease filling a front region of the tank 12 (e.g., with the front fill pipe 68 extending internally within the tank 12 to a region near the front of the tank 12). The rear fill pipe control valve 74 can be selectively opened and closed to fill or cease filling a rear region of the tank 12 (e.g., with the rear fill pipe 70 extending internally within the tank 12 to a region near the rear of the tank 12). The front fill pipe control valve 72 and the rear fill pipe control valve 74 can be any suitable valve for controlling the flow of air and material (e.g., pneumatically conveyed material). For example, the front fill pipe control valve 72 and the rear fill pipe control valve 74 can be a quarter turn butterfly valve actuated manually, pneumatically, electrically, or otherwise manipulable to control flow.

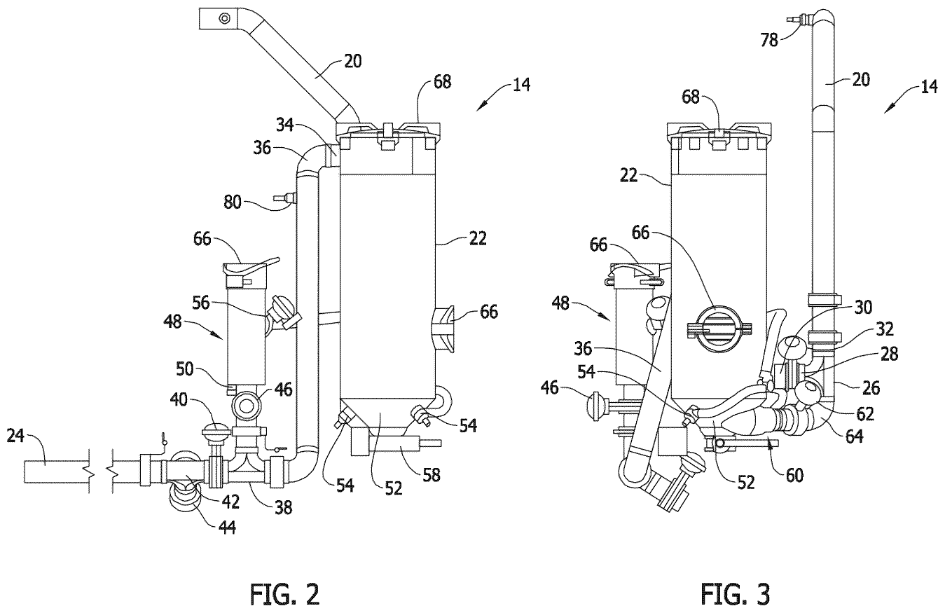

Referring now to FIGS. 2-5 and 11-13, in some embodiments the valves of the filtration system 14 and related systems are manually actuated valves (e.g., butterfly valves that are manually activated using a handle). In the depicted embodiment, many of the valves are electrically activated butterfly valves. This allows for automatic or manual control of the valves. For example, the valves can be electrically activated but only in response to manual control inputs (e.g., through a control system 76). In the preferred embodiment, the filtration system 14, the electrically activated valves (e.g., dusty air inlet valve 32, vacuum shut off valve 40, vacuum dump valve 44, atmospheric inlet valve 46, optional aeration valve 56, dust recycle valve 62, etc.), and the control system 76 allow for some automatic control of the filtration system 14 and the dry bulk trailer 10 as a whole (e.g., for automatic cleaning of the filter media).

To provide for automatic operation, the dry bulk trailer 10 includes a plurality of pressure sensors. A dusty air pressure sensor 78 is in fluid communication with the dusty air inlet 20. A clean air pressure sensor 80 is in fluid communication with the clean air line 36. Both sensors are any suitable sensor for measuring pressure. In the preferred embodiment, the sensors are of a type suitable to convert a pressure reading to an electric signal (analog or digital) for processing by the control system 76. For example, and without limitation, the sensors can be a piezoresistive strain gauge or type of strain gauge-based sensor suitable for measuring the pressure within a pipe or other container. The clean air pressure sensor 80 can be a combined vacuum-pressure sensor with a range of approximately −15 pounds per square inch to 30 pounds per square inch. The clean air pressure sensor 80 can be located at any point on the blower side of the filter media but in the depicted embodiment is positioned to measure pressure in the clean air line 36. The dusty air pressure sensor 78 can be a combined vacuum-pressure sensor with a range of approximately −15 pounds per square inch to 30 pounds per square inch. The dusty air pressure sensor 78 can be located at any point on the fill pipe 16 side of the filter media but in the depicted embodiment is positioned to measure pressure in the dusty air inlet 20. The dusty air pressure sensor 78 can be used to measure the current pressure in the tank 12 (the dusty air inlet 20 being in fluid communication with the tank 12) which is useful information for the operator of the tank trailer and/or can be used by the control system 76.

The control system 76 utilizes the signals from the dusty air pressure sensor 78 and the clean air pressure sensor 80 to control one or more of the valves of the filtration system 14 and/or the dry bulk trailer 10 in order to provide for the functions described herein (e.g., automatic cleaning on the filter media through the reversal of air flow across the filter media). The control system 76 include or otherwise performs the functions of a data acquisition system, controller for controlling the valves through the provision of control signals (electric, pneumatic, etc.), logic control for the processing of input signals, user input devices for manual control of the valves or the control system itself, displays for conveying information to a user, other input or output devices, input for receiving valve position indicating signals, modules, etc. It should be understood that any suitable combination of systems and/or components can be used to provide for the functions of the control system 76 described herein. For example, the control system 76 can be or ASIC, FPGA, a system-on-chip a processor (shared, dedicated, or group) that performs instructions included in code, including for example, execution of executable code instructions and/or interpretation/translation of uncompiled code, memory for storage of code, instructions, or the like for execution by the processor, communications hardware, or other suitable hardware components that provide the described functionality.

In operation, the control system 76 can provide for automatic filtration system 14 cleaning cycles. For example, this operation can be triggered by receiving a user input through an autoload button 77. While the tank 12 is being loaded, the control system 76 receives signals from the dusty air pressure sensor 78 and the clean air pressure sensor 80 corresponding to the pressure in the dusty air inlet 20 and the clean air line 36. The control system 76 subtracts the pressure values corresponding to the two signals to determine the differential pressure between the dusty air inlet 20 and the clean air line 36. This differential pressure corresponds to the differential pressure across the filter media and/or between the input and output of the filter canister 22. When the control system 76 determines that the differential pressure meets or exceeds a threshold value, the control system 76 actuates the appropriate valves through corresponding control signals to clean the filter media as will be described in greater detail with respect to FIGS. 12 and 13 (e.g., by reversing airflow across the filter media). For example, the threshold value can be 25 inches of water (e.g., approximately 1 pound per square inch). In other words, the dust air pressure sensor 78 will measure pressure corresponding to the vacuum in the tank 12 used for loading the material. In an ideal case, the pressure measured by the clean air pressure sensor 80 in the clean air line 36 is the same corresponding to a vacuum provided by the blower being the same across the filter media. However, as the filter media becomes obstructed, the vacuum in the tank 12 will be decreased relative to the vacuum in the clean air line 36 provided by the blower. Once this differential pressure reaches the threshold value (e.g., approximately 1 pound per square inch), the control system 76 can actuate the valves for a cleaning cycle. Advantageously, this allows for the control system 76 to better maintain the vacuum in the tank 12 for efficient loading of the material. The control system 76 can display pressure readings from the sensors, differential pressure, and/or additional information. This can allow an operator of the system to manually control the loading, cleaning, or other processes as desired based on the provided information.

In alternative embodiments, the cleaning cycle is actuated manually using the control system 76 or manually in the absence of a control system by manipulating the corresponding valves. In such alternative embodiments with a control system 76, the control system 76 can provide differential pressure information, a warning, or the like that indicates to a user that a cleaning cycle should be effectuated.

In some embodiments, the control system provides for additional functions. For example, the control system 76 can be used to automatically clean the filter media based on elapsed time. In such an embodiment, the control system 76 can start a timer based on detected position of the one or more valve positions associated with loading the tank 12. Once the timer has elapsed, the control system 76 can control the valves to clean the filter media (e.g., as will be described in greater detail with respect to FIGS. 12-13). After the cleaning, the control system 76 can control the valves to resume loading material and can reset the timer for future cleaning. For example, in some embodiments, the control system 76 automatically cleans the filter media every 10 minutes. In some embodiments, the control system 76 allow for manual triggering of the cleaning cycle by pushing a corresponding button (e.g., button 79). Upon registering the input, the control system 76 triggers the cleaning cycle. The control system 76 can also allow for an operator to select loading by the front fill pipe 68 or the rear fill pipe 70 (e.g., using buttons 81 and 83, respectively). This causes the control system 76 to appropriately actuate the corresponding valves 72, 74. Similarly, the control system 76 can close both fill pipe valves 72, 74 upon registering an input from a corresponding button 85. In some embodiments, the control system 76 further includes a button 87 to control the operation of the aerators 54. For example, upon receiving an input signal from button 87, the control system can actuate the aeration valve 56 to an open position providing air to the aerators 54. The control system 76 can provide such control using any suitable scheme including, for example, opening and then closing the valve after a predetermined period of time elapses, opening and then closing the valve when a coextensive automatic or manual clean operation has concluded, opening the valve and then closing the valve when receiving another input signal from button 87 (e.g., the button 87 operating as a toggle), using the button 87 as toggle which provides aeration or does not provide aeration, depending on toggle state, when other cleaning operations are triggered (e.g., automatic or manual cleaning), etc. It should also be noted that the control system 76 can include further components such as status indicator lights 89, display screens 91, or the like for conveying information (e.g., pressure sensor values, determined differential pressure, time remaining on operations such as cleaning, valve states, etc.).

In alternative embodiments, the pressure sensors and/or the control system 76 can be mechanical rather than electrical. For example, the control system can be implemented using pneumatic control elements, hydraulic control elements, or the like.

Referring now to FIGS. 12-13, operation of the valves for loading the tank and for cleaning the filter media and/or canister 22 is explained in greater detail. FIG. 12 illustrates the position of the relevant valves in filling the tank 12. FIG. 13 illustrates the position of the relevant valves in cleaning the filter media of the filtration system 14. In loading the tank 12, the dusty air inlet valve 32 and the vacuum shut off valve 40 are actuated to an open position. This allows for the blower to generate vacuum by pulling air through the fill pipe 16 and the tank 12 into the filtration system 14. Clean air exits the filtration system 14 and is expelled by the blower. In loading the tank 12, the dust recycle valve 62, the vacuum dump valve 44, and the atmospheric inlet valve 46 are actuated to the closed position. In embodiments including an aeration system, the optional aeration valve 56 is actuated to the closed position. By closing all valves in fluid communication with the atmosphere, the blower is capable of building a vacuum in the tank 12 to convey material into the tank 12.

When cleaning of the filter media is desired (e.g., by automatic control of the control system 76, manual control, etc.), the valves are actuated to reverse the flow of air across the filter media. The vacuum shut off valve 40 is closed to prevent the blower from continuing to build vacuum in the tank 12. To relieve stress on the blower, the vacuum dump valve 44 is opened. This allows the blower to pull atmospheric air and discharge it at reduced load on the blower while the vacuum shut off valve 40 being closed prevents further vacuum from being built in the tank 12. Opening the vacuum dump valve 44 also allows the blower to draw atmospheric air to cool the blower. To reverse the flow of air across the filter media to dislodge built up material, air must be provided. To provide air for this purpose, the atmospheric inlet valve 46 is opened. Because the atmospheric inlet valve 46 is in fluid communication with the atmosphere and in fluid communication with the tank 12 which is under residual vacuum from the loading process, the vacuum in the tank 12 draws air through the atmospheric inlet valve 46. The air crosses the filter media in reverse to the loading operation and dislodges material built up on the other side of the filter media. In embodiments including the air inlet filter 48, the atmospheric air is drawn through the filter then through the atmospheric inlet valve 46 and into the canister 22. The dust recycle valve 62 is also opened to allow the dust and material removed from the filter material and/or material collected in the canister 22 to be returned to the tank 12 (again under vacuum from the tank 12) through the dust recycle line 62. As previously noted, positioning the dust recycle line 62 low on the canister 22 provides for greater collection of the dust/material. When cleaning the filter media, the dusty air inlet valve 32 is also closed to promote return of the material from the bottom of the canister 22.

In embodiments that include aerators 54, the aeration valve 56 is also opened during cleaning. This provides aeration to the material collected in the bottom of the canister 22. The aeration facilitates the removal of the material from the canister in cleaning. The aeration valve 56 is closed when loading the tank 12.

Advantageously, cleaning the filter media using the residual vacuum in the tank 12 allows for cleaning while loading continues. This is because the vacuum in the tank 12 also continues to draw in the material being loaded while the filter medial is cleaned by reversed air flow. Also, the return of cleaned material through the dusty air inlet 20 rather than a fill pipe 16 further aides in the continued filling of the tank 12. This allows for material to continue moving into the tank 12 from the fill pipe 16 while cleaned material also flows into the tank 12 without being impeded by or impeding loading through the fill pipe 16. Cleaning the filter media and/or canister 22 while loading continues increases the loading efficiency as loading does not need to cease while the filter media is cleaned allowing for operation at improved efficiency (e.g., with a clean filter media). The filter media can also be cleaned when loading is complete to recycle the collected material from the canister 22 into the tank 12. This maximizes the amount of the material that is transported and unloaded (e.g., not leaving material behind in the canister 22). This allows for more material to be transported. It also prevents the need and expense in disposing of material from the canister 22.

It should be understood, as previously noted, that operation of the valves as described can be fully automatic, partially automatic (e.g., in response to a manual control system 76 input), or can be entirely manual with manually actuated valves.

In alternative embodiments, the filtration system 14 and/or the conveyance system of the dry bulk tank trailer 10 can use other systems to reverse air flow across the filter media for cleaning (e.g., as opposed to relying on the residual vacuum in the tank 12). For example, a pressure line being output from a blower can be in fluid communication with the clean air side of the filter material (e.g., a blower output can be in fluid communication with the clean air line 36 and a valve to control reverse flow into the clean air line 36). The valve can be actuated to allow for clean air from the blower to be returned, in reverse flow, back into the canister 22 for cleaning the filter material. The dust recycle valve 62 is opened and the dusty air inlet line valve 32 is closed.

From the foregoing, the advantages of the described system can be appreciated.

Changes can be made in the above constructions without departing from the scope of the disclosure. It is intended that all matter contained in the above description or shown in the accompanying drawings shall be interpreted as illustrative and not in a limiting sense. These examples are merely illustrative.

1. A filtration system for a dry bulk trailer, the dry bulk trailer having at least a tank for storing dry bulk granular material and a fill pipe communicating with the tank for loading material into the tank, the dry bulk trailer being adapted and configured to load and unload material by pneumatic conveyance, the filtration system comprising:
a canister, the canister having a dusty air inlet on the canister and a clean air outlet on the canister;
a filter media inside the canister, the filter media being positioned between and separating the dusty air inlet on the canister and the clean air outlet on the canister, the filter media being operable to block material conveyed by a flow of air received into the canister through the dusty air inlet on the canister from passing through the filter media while enabling the air received through the dusty air inlet on the canister to pass through the filter media and exit the canister through the clean air outlet on the canister;
a dusty air line connected to the dusty air inlet on the canister, the dusty air line having a connector for connecting the dusty air line to a tank of a dry bulk trailer whereby the dusty air line connects the tank and the canister in fluid communication such that during pneumatic loading of the tank the dusty air line communicates air being used to pneumatically convey material into the tank from the tank to the canister for filtration by the filter media inside the canister;
a clean air line connected to the clean air outlet on the canister, the clean air line communicating with an exterior environment atmosphere of the canister whereby the clean air line communicates air that has been cleaned by the filter media in the canister to the exterior environment atmosphere;
wherein the filtration system is operable in a loading mode defining a dusty air path of material in air conveyed by pneumatic conveyance into a tank of a dry bulk trailer that flows from the tank through the dusty air line and through the dusty air inlet on the canister, into the canister, through the filter media inside the canister and out of the canister through the clean air outlet on the canister and through the clean air line to the exterior environment atmosphere; and
wherein the filtration system is operable in a cleaning mode defining a clean air path of air from the exterior environment atmosphere through the clean air line and the clean air outlet on the canister into the canister, across the filter media to dislodge material deposited on the filter media, out of the canister through the dusty air inlet on the canister and through the dusty air line to the tank with material dislodged from the filter media.

2. The filtration system of claim 1, further comprising:
the dusty air line is separated from the fill pipe for loading the material into the tank.

3. The filtration system of claim 1, further comprising:
a vacuum source that is connectable in communication with the clean air line, the vacuum source being operable to create a vacuum through the clean air line and within the tank whereby the vacuum pneumatically conveys material into the tank through the fill pipe, and the vacuum source is disconnectable from communication with the clean air line to leave a residual vacuum in the tank that draws air from the clean air line, through the clean air outlet on the canister and into the canister, across the filter media inside the canister dislodging material deposited on the filter media, and from the canister through the dusty air inlet on the canister and through the dusty air line to the tank.

4. The filtration system of claim 3, further comprising:
the vacuum source is a blower that is connectable in communication with the clean air line and is operable to create a vacuum through the clean air line and within the tank that pneumatically conveys material through the fill pipe and into the tank.

5. The filtration system of claim 1, further comprising:
a positive pressure source that is connectable in communication with the clean air line, the positive pressure source being operable to produce positive pressure to reverse air flow through the filtration system when the filtration system is in the cleaning mode, the positive pressure source being operable to deliver positive pressure air through the clean air line, through the clean air outlet on the canister, into the canister and across the filter media inside the canister to dislodge material deposited on the filter media, and from the canister through the dusty air inlet on the canister and through the dusty air line to the tank.

6. The filtration system of claim 5, further comprising:
a positive pressure source that is connectable to the fill pipe, the positive pressure source being operable to produce a flow of air and convey material with the flow of air through the fill pipe and into the tank, from the tank through the dusty air line and the dusty air inlet on the canister, into the canister and through the filter media inside the canister, from the canister through the clean air outlet on the canister and through the clean air line.

7. The filtration system of claim 1, further comprising:
a vacuum dump valve connected to the clean air line, the vacuum dump valve being operable to communicate the clean air line with the exterior environment atmosphere;
a vacuum shut off valve connected to the clean air line between the vacuum dump valve and the canister; and
an atmospheric inlet valve connected to the clean air line, the atmospheric inlet valve being operable to communicate the clean air line with the exterior environment atmosphere, the atmospheric inlet valve being connected to the clean air line between the vacuum shut off valve and the canister.

8. The filtration system of claim 7, further comprising:
a vacuum source connected to the clean air line;
the vacuum shut off valve being connected to the clean air line between the vacuum source and the canister, the vacuum shut off valve being operable to close the clean air line and separate the vacuum source from the canister and the tank;
the vacuum dump valve being operable to open the clean air line and communicate the vacuum source with the exterior environment atmosphere through the clean air line; and
the atmospheric inlet valve being operable to open the clean air line and communicate the clean air line with the exterior environment atmosphere.

9. The filtration system of claim 8, further comprising:
the filtration system is adapted and configured to operate in a cleaning mode with the vacuum shut off valve being closed preventing communication of vacuum to the tank;
the vacuum dump valve being opened relieving stress on the vacuum source by communicating the vacuum source with the exterior environment atmosphere;
the atmospheric inlet valve being opened providing fluid communication between the exterior environment atmosphere and the canister whereby residual vacuum in the tank draws air from the exterior environment atmosphere, through the atmospheric inlet valve and through the clean air line, into the canister and across the filter media inside the canister dislodging material on the filter media, and through the dusty air inlet on the canister and the dusty air line into the tank.

10. The filtration system of claim 9, further comprising:
an inlet air filter connected in communication with the atmospheric inlet valve.

11. The filtration system of claim 10, further comprising:
an aerator connected on the canister, the aerator being operable to communicate air from the exterior environment atmosphere into the canister to fluidize material collected in the canister; and
an aeration valve connected in communication with the aerator, the aeration valve being operable to provide air from the exterior environment atmosphere to the aerator.

12. The filtration system of claim 11, further comprising:
a dusty air inlet line connected to the canister;
a dusty air line fitting connected to the dusty air inlet line and to the dusty air line;
the dusty air line, the dusty air line fitting and the dusty air inlet line communicating dusty air from the tank into the canister;
a dust recycle line connected to the canister, the dust recycle line connected to the dusty air line fitting, the dust recycle line communicating with the dusty air line through the dusty air line fitting, the dust recycle line communicating material removed from the filter media from the canister through the dusty air line fitting and the dusty air line to the tank when the filtration system is in the cleaning mode;
a dusty air inlet line valve connected to the dusty air inlet line, the dusty air inlet line valve being operable to selectively open and close communication through the dusty air inlet line;
a dust recycle valve connected to the dust recycle line, the dust recycle valve being operable to selectively open and close communication through the dust recycle line; and
the dust recycle line is connected to the canister below the dusty air inlet line connected to the canister.

13. The filtration system of claim 12, further comprising:
a control system operatively connected to the vacuum dump valve, the vacuum shut off valve, the atmosphere inlet valve, the aeration valve, the dusty air inlet line valve and the dust recycle valve and being operable to control the valves in the cleaning mode and loading mode.

14. A filtration system for a dry bulk trailer, the dry bulk trailer having at least a tank for storing dry bulk granular material and a fill pipe communicating with the tank for loading material into the tank, the dry bulk trailer being adapted and configured to load and unload material by pneumatic conveyance, the filtration system comprising:
a canister, the canister having a dusty air inlet on the canister and a clean air outlet on the canister;
a filter media inside the canister, the filter media being positioned between and separating the dusty air inlet on the canister and the clean air outlet on the canister, the filter media being operable to block material conveyed by a flow of air received into the canister through the dusty air inlet on the canister from passing through the filter media while enabling the air received through the dusty air inlet on the canister to pass through the filter media and exit the canister through the clean air outlet on the canister;
a dusty air line connected to the dusty air inlet on the canister, the dusty air line having a connector for connecting the dusty air line to a tank of a dry bulk trailer whereby the dusty air line connects the tank and the canister in fluid communication such that during pneumatic loading of the tank the dusty air line communicates air being used to pneumatically convey material into the tank from the tank to the canister for filtration by the filter media inside the canister;
a clean air line connected to the clean air outlet on the canister, the clean air line communicating with an exterior environment atmosphere of the canister whereby the clean air line communicates air that has been cleaned by the filter media in the canister to the exterior environment atmosphere;
a vacuum source connected to the clean air line;
wherein the filtration system is operable in a loading mode defining a dusty air path of material conveyed by pneumatic conveyance into the tank of a dry bulk trailer as a result of vacuum created in the tank by the vacuum source drawing air through the dusty air line and through the dusty air inlet on the canister, into the canister, through the filter media inside the canister and out of the canister through the clean air outlet on the canister and through the clean air line to the exterior environment atmosphere; and
wherein the filtration system is operable in a cleaning mode wherein airflow is reversed relative to the loading mode defining a clean air path of air from the exterior environment atmosphere through the clean air line and the clean air outlet on the canister into the canister, across the filter media to dislodge material deposited on the filter media, out of the canister through the dusty air inlet on the canister and through the dusty air line to the tank with material dislodged from the filter media, reversal of the airflow being effectuated by a residual vacuum in the tank as a result of operation in the loading mode.

15. The filtration system of claim 14, further comprising:
a vacuum dump valve connected to the clean air line, the vacuum dump valve being operable to communicate the clean air line with the exterior environment atmosphere;
a vacuum shut off valve connected to the clean air line between the vacuum dump valve and the canister;
an atmospheric inlet valve connected to the clean air line, the atmospheric inlet valve being operable to communicate the clean air line with the exterior environment atmosphere, the atmospheric inlet valve being connected to the clean air line between the vacuum shut off valve and the canister;
the vacuum shut off valve being connected to the clean air line between the vacuum source and the canister, the vacuum shut off valve being operable to close the clean air line and separate the vacuum source from the canister and the tank;
the vacuum dump valve being operable to open the clean air line and communicate the vacuum source with the exterior environment atmosphere through the clean air line; and
the atmospheric inlet valve being operable to open the clean air line and communicate the clean air line with the exterior environment atmosphere;
and wherein the filtration system is adapted and configured to operate in the cleaning mode wherein the vacuum shut off valve is closed to prevent communication of vacuum to the tank, the vacuum dump valve is open to communicate the vacuum source in fluid communication with the exterior environment atmosphere, the atmospheric inlet valve is opened communicating the exterior environment atmosphere and the canister such that a residual vacuum in the tank from operation in the loading mode draws air from the exterior environment atmosphere in through the atmospheric inlet valve, through the clean air outlet on the canister and into the canister, across the filter media dislodging material on the filter media, and conveying the material into the tank.

16. The filtration system of claim 15, further comprising:
a dusty air inlet line connected to the canister;
a dusty air line fitting connected to the dusty air inlet line and to the dusty air line;
the dusty air line, the dusty air line fitting and the dusty air inlet line communicating dusty air from the tank into the canister;
a dust recycle line connected to the canister, the dust recycle line connected to the dusty air line fitting, the dust recycle line communicating with the dusty air line through the dusty air line fitting, the dust recycle line communicating material removed from the filter media from the canister through the dusty air line fitting and the dusty air line to the tank when the filtration system is in the cleaning mode;
a dusty air inlet line valve connected to the dusty air inlet line, the dusty air inlet line valve being operable to selectively open and close communication through the dusty air inlet line;
a dust recycle valve connected to the dust recycle line, the dust recycle valve being operable to selectively open and close communication through the dust recycle line;
the dust recycle line is connected to the canister below the dusty air inlet line connected to the canister; and
wherein the filtration system is adapted and configured to operate in the cleaning mode when dust recycle valve is opened and the dusty air inlet line valve is closed.

17. A filtration system for a dry bulk trailer, the dry bulk trailer having at least a tank for storing dry bulk granular material and a fill pipe communicating with the tank for loading material into the tank, the dry bulk trailer being adapted and configured to load and unload material by pneumatic conveyance, the filtration system comprising:
a canister, the canister having a dusty air inlet on the canister and a clean air outlet on the canister;
a filter media inside the canister, the filter media being positioned between and separating the dusty air inlet on the canister and the clean air outlet on the canister, the filter media being operable to block material conveyed by a flow of air received into the canister through the dusty air inlet on the canister from passing through the filter media while enabling the air received through the dusty air inlet on the canister to pass through the filter media and exit the canister through the clean air outlet on the canister;
a dusty air line connected to the dusty air inlet on the canister, the dusty air line having a connector for connecting the dusty air line to a tank of a dry bulk trailer whereby the dusty air line connects the tank and the canister in fluid communication such that during pneumatic loading of the tank the dusty air line communicates air being used to pneumatically convey material into the tank from the tank to the canister for filtration by the filter media inside the canister;
a clean air line connected to the clean air outlet on the canister, the clean air line communicating with an exterior environment atmosphere of the canister whereby the clean air line communicates air that has been cleaned by the filter media in the canister to the exterior environment atmosphere;
a vacuum source connected to the clean air line;
a plurality of control valves including a vacuum dump valve connected to the clean air line, the vacuum dump valve being operable to communicate the clean air line with the exterior environment atmosphere;
a vacuum shut off valve connected to the clean air line between the vacuum dump valve and the canister;
an atmospheric inlet valve connected to the clean air line, the atmospheric inlet valve being operable to communicate the clean air line with the exterior environment atmosphere, the atmospheric inlet valve being connected to the clean air line between the vacuum shut off valve and the canister;
the vacuum shut off valve being connected to the clean air line between the vacuum source and the canister, the vacuum shut off valve being operable to close the clean air line and separate the vacuum source from the canister and the tank;
the vacuum dump valve being operable to close the clean air line and communicate the vacuum source with the exterior environment atmosphere through the clean air line;
the atmospheric inlet valve being operable to open the clean air line and communicate the clean air line with the exterior environment atmosphere;
a dusty air pressure sensor connected in communication with the dusty air inlet on the canister;
a clean air pressure sensor connected in communication with the clean air line;
a control system connected in operative communication with the plurality of control valves and adapted and configured to control one or more of the plurality of control valves based on one or more signals from one or more of the dusty air pressure sensor and the clean air pressure sensor;
wherein the filtration system is adapted and configured to operate in a loading mode wherein material is conveyed into the tank by pneumatic conveyance as a result of vacuum created in the tank by the vacuum source drawing air through the dusty air line and through the dusty air inlet on the canister, into the canister, through the filter media inside the canister and out of the canister through the clean air outlet on the canister and through the clean air line to the vacuum source;
wherein the filtration system is adapted and configured to operate in a cleaning mode wherein airflow is reversed relative to the loading mode and air flows from the exterior environment atmosphere through the clean air line and the clean air outlet on the canister into the canister, across the filter media to dislodge material deposited on the filter media, exiting the canister through the dusty air inlet on the canister and through the dusty air line to the tank with material dislodged from the filter media, the reversal of the airflow being effectuated by a residual vacuum in the tank as a result of operation in the loading mode; and
wherein the control system is adapted and configured to determine a differential pressure across the filter media by taking the difference of the pressure determined by the dusty air pressure sensor and the pressure determined by the clean air pressure sensor, wherein the control system is adapted and configured to control the plurality of control valves to cause the filtration system to operate in the cleaning mode when the differential pressure determined by the control system exceeds a predetermined threshold.

18. The filtration system of claim 17, further comprising:
the control system is adapted and configured to control the plurality of control valves to operate the filtration system in the cleaning mode by sending control signals to cause the plurality of control valves to enter the following states:
the vacuum shut off valve is closed to prevent further communication of vacuum to the tank, the vacuum dump valve is open to communicate the vacuum source with the exterior environment atmosphere, and the atmospheric inlet valve is open to communicate the exterior environment atmosphere with the canister such that residual vacuum in the tank draws air in through from the exterior environment atmosphere, through the atmospheric inlet valve, into the canister, across the filter media dislodging material from the filter media, and conveying the material into the tank through the dusty air inlet on the canister and the dusty air line.

19. The filtration system of claim 18, further comprising:
a dusty air inlet line connected to the canister;
a dusty air line fitting connected to the dusty air inlet line and to the dusty air line;
the dusty air line, the dusty air line fitting and the dusty air inlet line communicating dusty air from the tank into the canister;
a dust recycle line connected to the canister, the dust recycle line connected to the dusty air line fitting, the dust recycle line communicating with the dusty air line through the dusty air line fitting, the dust recycle line communicating material removed from the filter media from the canister through the dusty air line fitting and the dusty air line to the tank when the filtration system is in the cleaning mode;
a dusty air inlet line valve connected to the dusty air inlet line, the dusty air inlet line valve being operable to selectively open and close communication through the dusty air inlet line;
a dust recycle valve connected to the dust recycle line, the dust recycle valve being operable to selectively open and close communication through the dust recycle line; and
the dust recycle line is connected to the canister below the dusty air inlet line connected to the canister.

20. The filtration system of claim 19, further comprising:
the control system is adapted and configured to control one or more of the plurality of control valves to operate the filtration system in the cleaning mode by sending control signals to cause the dust recycle valve to be in an open state and cause the dusty air inlet line valve to be in a closed state.
